(19) United States
(12) Patent Application Publication
(10) Pub. No.: US 2014/0319259 A1
(43) Pub. Date: Oct. 30, 2014

(54) STRUCTURE OF CRUSHER

(71) Applicant: MINYU MACHINERY CORP. LTD., Taoyuan (TW)

(72) Inventor: MING-YIH CHENG, Taoyuan (TW)

(73) Assignee: Minyu Machinery Corp. Ltd., Taoyuan (TW)

(21) Appl. No.: 13/870,995

(22) Filed: Apr. 26, 2013

(51) Int. Cl. B02C 25/00; B02C 1/00

(52) U.S. Cl. CPC B02C 25/00; B02C 1/005
USPC 241/283; 241/285.1

(57) ABSTRACT

A crusher includes a main body that includes a crushing structure and an adjustment structure. The adjustment structure includes an adjustment hydraulic cylinder, a slide block mechanism, which is operatively coupled to the adjustment hydraulic cylinder, and a pull bar hydraulic cylinder, which is operable in combination with the adjustment hydraulic cylinder and the slide block mechanism. The adjustment structure includes an operation control module for adjusting a crushing gap and effecting position returning after an operation problem is removed. With such an arrangement, in operation, the operation control module issues a command to actuate the adjustment hydraulic cylinder for adjusting a crushing gap of the crushing structure. When an excessively high pressure occurs due to jamming, coordination between the adjustment hydraulic cylinder and the operation control module enables fast expansion of the gap to the maximum for removing a jamming object and automatic returning to the initial gap setting.

### (a) TECHNICAL FIELD OF THE INVENTION

The present invention generally relates to an improved structure of crusher, and more particularly to an improved structure of crusher featuring fast gap adjustment and automatic returning.

### (b) DESCRIPTION OF THE PRIOR ART

All buildings are constructed by being built up on ground. Various buildings and facility are constructed with stones and rocks and are thus strong and close to the nature.

Stones and rocks are collected and then crushed to be used in combination with other construction materials to serve as the basic material for construction. Breaking stones or rocks can be done manually and this is time- and labor-consuming. In addition, the sizes of rock pieces so broken are not consistent, making it inconvenient for the subsequent operation.

To cope with such a problem., crushers that are developed for crushing and breaking stones and rocks are available in the market. Rocks are broken by being compressed by a movable plate that is driven by motors. This enhances the operation efficiency and allows of proper control of the size of broken rock pieces.

Referring to FIG. 5, a schematic view of a conventional crusher is shown. The drawing clearly shows that a crusher 500 comprises a rotary power wheel that makes circumferential movement and is operated with an eccentric structure so as to drive a movable plate to reciprocally move. A pull bar 501 and pads 502 are used to set the stroke of crushing operation. When rocks or stones get into a crushing zone, the movable plate and a fixed plate cooperate with each other to effect compression so as to make the rocks and stones subjected to continuous squeezing and compression and thus getting broken to be eventually discharged from a bottom gap.

However, the conventional crusher has certain drawbacks and shortcomings that must be improved:

(1) Gap adjustment of the crusher 500 is done by stacking pads 502 to change the initial crushing gap and then using the pull bar 501 to control the crushing gap. The adjustment requires increasing or decreasing the number of pads 502 and this process of adding or removing pads is generally time- and labor-consuming.

(2) When the crusher 500 gets jammed, it again needs removing and installing the pads 502 and changing the pull bar 501. This is also a time- and labor-consuming. Further, since the adjustment of gap is effected by stacking the pads 502, there is always a difference occurring each time returning is made.

(3) The crusher 500 uses the pull bar 501 to control the crushing stroke. The pull bar 501 is an elastic member and thus, the operation of the crusher 500 will cause certain change to the crushing gap during the operation. This leads to imprecise control of crushing quality of the crushed object.

Thus, the present invention aims to overcome the above discussed drawbacks and shortcomings of the prior art.

### SUMMARY OF THE INVENTION

In view of the above drawbacks and shortcomings of the conventional devices, the present invention provides an improved structure of crusher that features fast gap adjustment and automatic returning.

A primary object of the present invention is that through coordination among an adjustment hydraulic cylinder, a slide block mechanism, and a pull bar hydraulic cylinder, fast adjustment of an initially-set gap and crushing gap can be realized so that through such a technique, the drawbacks of time- and labor-consuming operation of crushing gap adjustment occurring in the conventional crushers that is can be overcome and an advantage of fast adjustment of gap can be provided.

Another object of the present invention is that with an operation control module instructing to start an operation and to handle failure problem, the adjustment hydraulic cylinder and the pull bar hydraulic cylinder can efficiently remove any failure problem of jamming and effect automatic gap returning so that through such a technique, the drawbacks of time- and labor-consuming operation of failure removal and incapability of returning to the original setting of gap occurring in the conventional crushers can be overcome and an advantage of automatic returning can be provided.

To achieve the above objects, the present invention provides an improved structure of crusher that comprises a main body, on which a crushing structure and an adjustment structure are mounted. The adjustment structure comprises an adjustment hydraulic cylinder, which is mounted to the main body, a slide block mechanism, which is operatively coupled to the adjustment hydraulic cylinder, and a pull bar hydraulic cylinder, which is operable in combination with the adjustment hydraulic cylinder and the slide block mechanism.

The adjustment structure comprises an operation control module for adjusting a crushing gap and effecting position returning after an operation problem is removed.

With such an arrangement, to carry out a regular operation, the operation control module carries out setting of an initial gap and crushing gap for the adjustment structure. Coordination between the adjustment hydraulic cylinder and the pull bar hydraulic cylinder enables fast adjustment. When a failure, such as jamming, occurs, the operation control module issues an instruction again to the adjustment structure for removal of the failure by extending/retracting the adjustment hydraulic cylinder to expand the gap to the maximum so as to allow a jamming object to be discharged and subsequently returning back to the originally set gap. This process requires no dismounting/mounting of any component of the crusher and thus, an advantage of fast gap adjustment and automatic returning can be achieved.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a schematic view showing a preferred embodiment according to the present invention.

FIG. 2 is a structure block diagram of the preferred embodiment of the present invention.

FIG. 3 is a schematic view showing an adjustment structure of the preferred embodiment of the present invention.

FIG. 4 is a schematic view illustrating an operation of the preferred embodiment of the present invention.

FIG. 5 is a schematic view showing the structure of a conventional crusher.

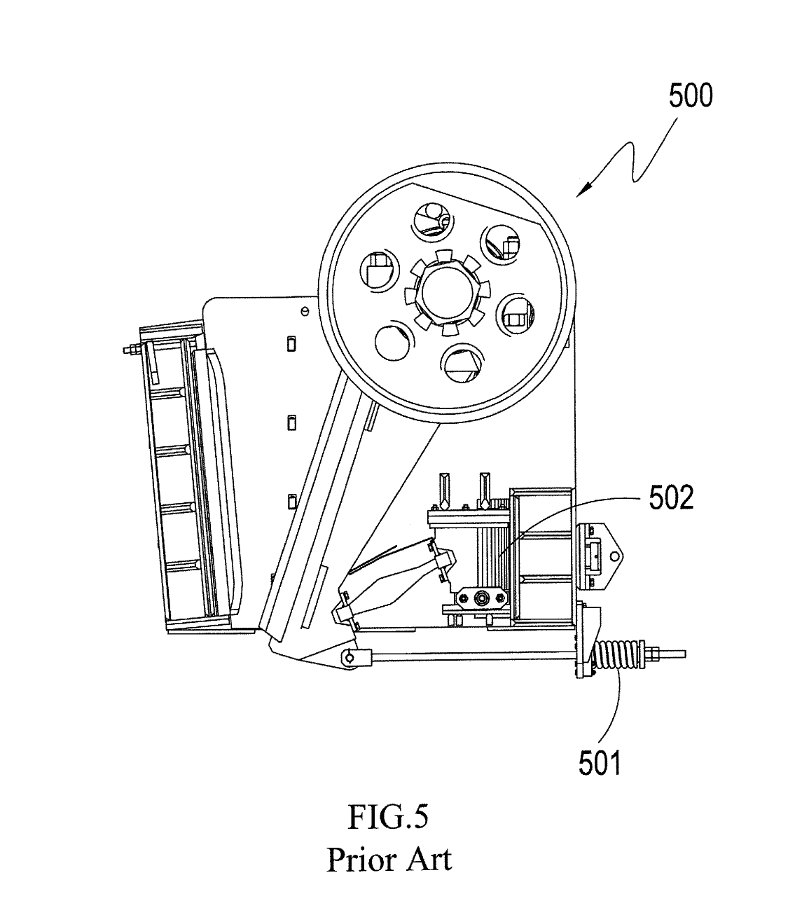

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

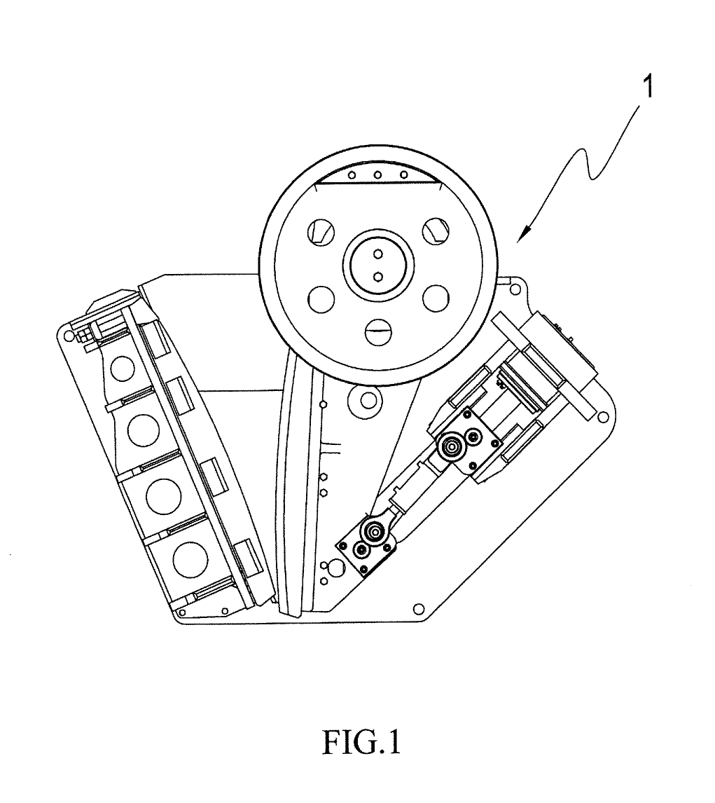

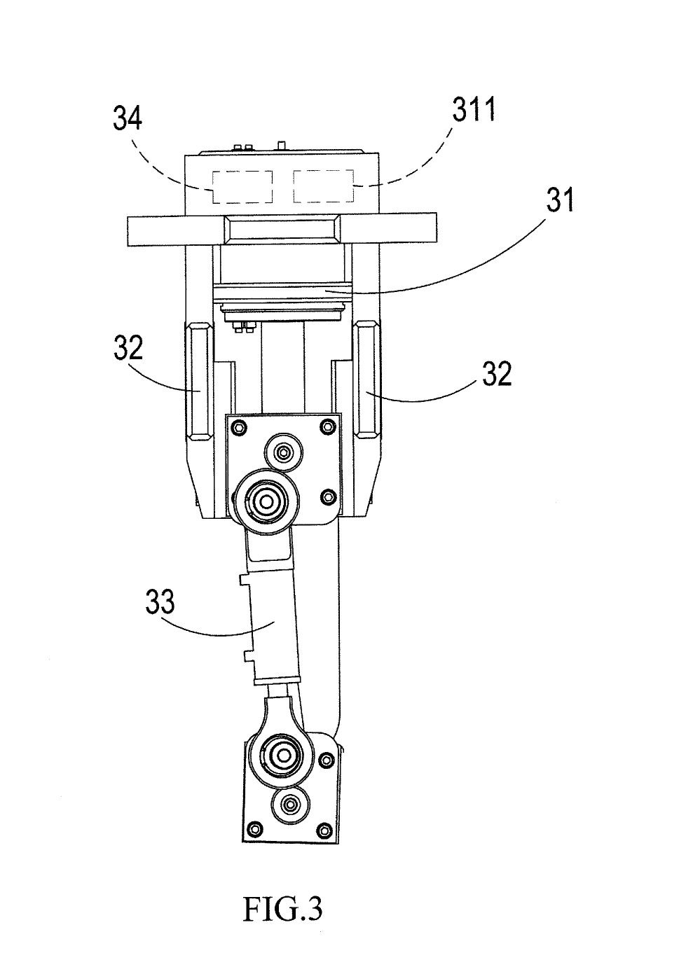

Referring to FIGS. 1, 2, and 3, which are respectively a schematic view of a preferred embodiment of the present invention, a structure block diagram of the preferred embodiment of the present invention, and a schematic view showing an adjustment structure of the preferred embodiment of the present invention, these drawings clearly show that a crusher according to the present invention comprises:

a main body 1;

a crushing structure 2, which is mounted on the main body 1, the crushing structure 2 comprising a power wheel assembly 21, a movable plate 22 that is mounted to the power wheel assembly 21 to effect reciprocal movement, and a fixed plate 23 that cooperates with the movable plate 22 to carry out a crushing operation; and

an adjustment structure 3, which is mounted on the main body 1 and comprises an adjustment hydraulic cylinder 31 mounted to the main body 1, a slide block mechanism 32 that is operatively coupled to the adjustment hydraulic cylinder 31, and a pull bar hydraulic cylinder 33 that is operable in combination with the adjustment hydraulic cylinder 31 and the slide block mechanism 32, the adjustment structure 3 having two ends that are respectively mounted to the main body 1 and the movable plate 22.

The adjustment structure 3 further comprises an operation control module 34 for adjusting a crushing gap and effecting position returning after an operation problem is removed.

The adjustment hydraulic cylinder 31 comprises a sensor element 311 arranged therein for detecting crushing pressure.

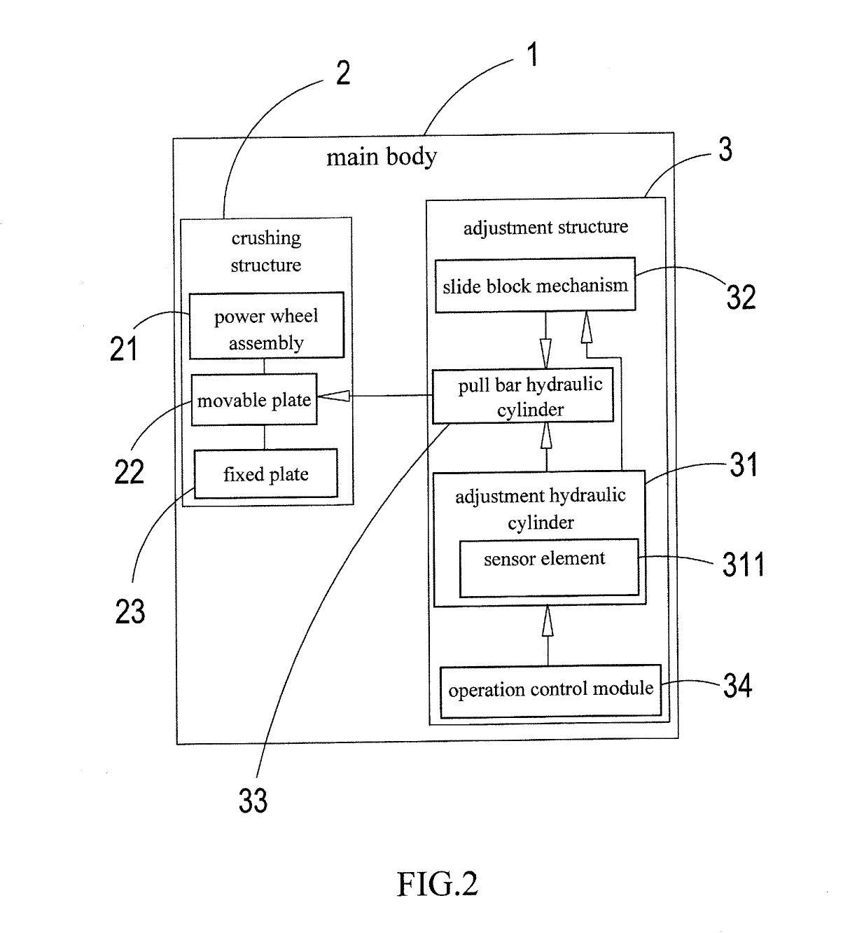

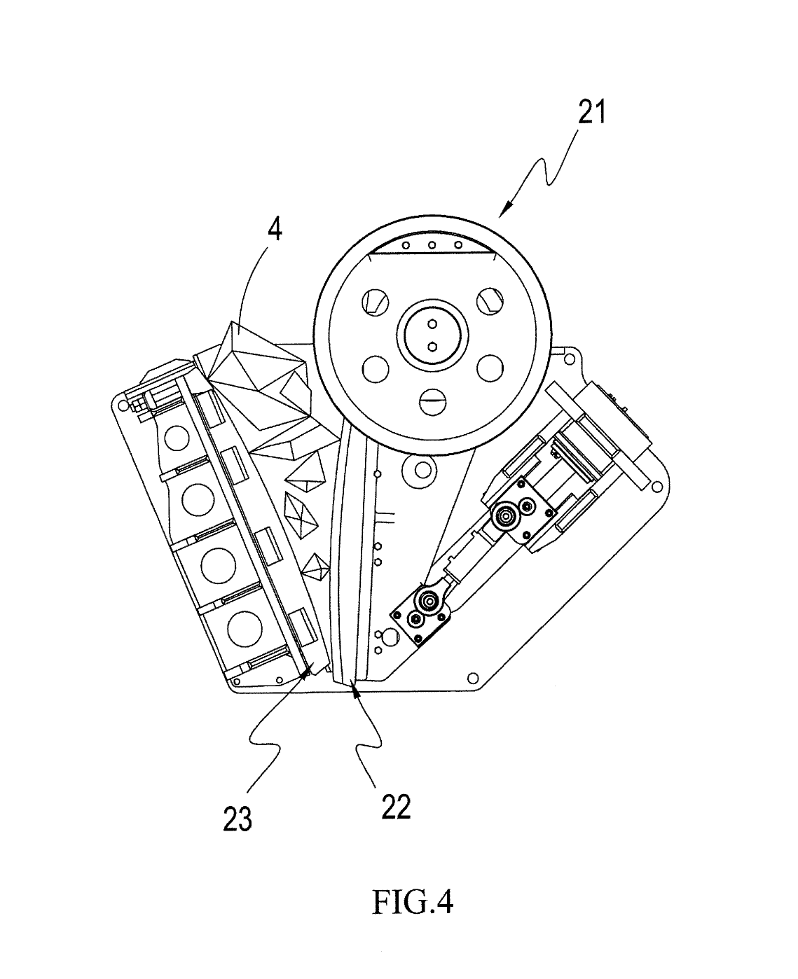

With the above described components and arrangement, the operation of the present invention is described as follows by referring to FIGS. 2, 3, and 4, which are respectively a structure block diagram of the preferred embodiment of the present invention, a schematic view showing the adjustment structure of the preferred embodiment of the present invention, and a schematic view illustrating an operation of the preferred embodiment of the present invention, as clearly shown in these drawings, to carry out a regulation operation, settings are made with the operation control module 34, wherein the operation control module 34 is operable to carry out position setting for achieving initial gap setting and also to carry out crushing stroke gap setting for crushing operation for the adjustment hydraulic cylinder 31, the slide block mechanism 32, and the pull bar hydraulic cylinder 33 and also to carry out changing gap for discharging after the crushing operation through extension/retraction of the adjustment structure 3. After the completion of the setting, a crushing operation can be carried out immediately, where an object-to-be-crushed 4 is placed into a crushing chamber between the fixed plate 23 and the movable plate 22. The object-to-be-crushed 4 is retained between the fixed plate 23 and the movable plate 22 due to the size thereof. The movable plate 22 is driven by the power wheel assembly 21 so that the movable plate 22 gradually compresses and crushes the object-to-be-crushed 4 thereby reducing the size of the object-to-be-crushed 4 to be eventually discharged through an opening at the bottom of the main body 1. When an event that an object-to-be-crushed 4 cannot be crushed (such as the object being a metal block, the object-to-be-crushed 4 being excessively rigid, an excessive number of objects-to-be-crushed 4 being simultaneously jammed at the same site) occurs, the sensor element 311 arranged inside the adjustment hydraulic cylinder 31 detects an excessive rise of pressure and issues a message back to the operation control module 34 in order to initiate a trouble-shooting operation corresponding to such a failure condition, where the operation control module 34 issues a command to the adjustment hydraulic cylinder 3 to cause an operation of extension/retraction of the adjustment hydraulic cylinder 3 that sets free the gap in such a way that the object 4 that cannot be crushed is allowed to freely drop from the bottom of the main body and subsequently, the operation control module 34 issues another command that causes the adjustment hydraulic cylinder 31 to return to the initial gap setting so that feeding of objects-to-be-crushed 4 can be continued and the crushing operation resumes. With such an arrangement, since the pull bar hydraulic cylinder 33 provides a force that is generated by hydraulic pressure and is thus very stable, the crushing operation performed with the present invention will not result in poor control of crushing quality caused by variation of the gap that generally occurs in a conventional crusher. With the arrangement and operation described above, the present invention may achieve practical advantages of fast gap adjustment and automatic returning.

Thus, as shown in all the drawings attached, the present invention shows various advantages over the prior art. Some of the advantages are listed as follows:

(1) When compared with the conventional way of adjustment that is made through adding and/or removing pads, the adjustment realized through the adjustment hydraulic cylinder 31 is efficient and labor-saving so that an advantage of fast gap adjustment is provided.

(2) Through the precise control provided by the operation control module 34, each time when position returning is made subsequent to removal of jamming or failure, the originally provided initial setting can be preserved with no change or difference occurring so that an advantage of fast gap adjustment and automatic returning is provided.

(3) Through the stable force provided by the pull bar hydraulic cylinder 33, no variation of gap may occur in an operating crusher due to vibration thereof so that an advantage of precise control of the quality of objects-to-be-crushed 4 is provided.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A crusher, comprises a main body that comprises a crushing structure and an adjustment structure, the adjustment structure comprising:
an adjustment hydraulic cylinder, which is mounted to the main body;
a slide block mechanism, which is operatively coupled to the adjustment hydraulic cylinder; and
a pull bar hydraulic cylinder, which is operable in combination with the adjustment hydraulic cylinder and the slide block mechanism.

2. The crusher according to claim 1, wherein the crushing structure comprises a power wheel assembly, a movable plate that is mounted to the power wheel assembly to effect reciprocal movement, and a fixed plate that cooperates with the movable plate to carry out a crushing operation.

3. The crusher according to claim 2, wherein the adjustment structure has an end mounted to the main body and another end mounted to a portion of the movable plate.

4. The crusher according to claim 1, wherein the adjustment structure comprises an operation control module for adjusting a crushing gap and effecting position returning after an operation problem is removed.

5. The crusher according to claim 1, wherein the adjustment hydraulic cylinder comprises a sensor element arranged therein for detecting crushing pressure.
